(19) United States
(12) Patent Application Publication
(10) Pub. No.: US 2026/0326654 A1
(43) Pub. Date: Oct. 22, 2026

(54) PAD EYE SYSTEM

(71) Applicant: Suncor Stainless, Inc., Plymouth, MA (US)

(72) Inventors: Patrick STRIEBEL, Duxbury, MA (US); David DION, Marion, MA (US); James STORRER, Middleboro, MA (US)

(73) Assignee: Suncor Stainless, Inc., Plymouth, MA (US)

(21) Appl. No.: 19/111,237

(22) PCT Filed: Oct. 4, 2023
(86) PCT No.: PCT/US2023/034470

§ 371 Date: Mar. 12, 2025

Related U.S. Application Data
(60) Provisional application No. 63/414,052, filed on Oct. 7, 2022.

(51) Int. Cl. B60P 7/08

(52) U.S. Cl. CPC B60P 7/0807

(57) ABSTRACT

In a pad eye system having one or more rings, the rings are structured respectively as one or more geometric shapes with a consistent material dimeter throughout. The pad eyes include one or more pad eye bases attached respectively to the rings and configured to rotate respectively about a common axis. The pad eye bases include a first bore and one or more mounting holes. In the disclosed system, the pad eyes can comprise various shaped rings in various combinations with several mounting bases. Additionally, the disclosed pad eye system and assemblies can further be combined with pan fittings in either a surface or recessed type mount to create additional fittings. According to some implementations, the components and/or fittings are made from metal, such as stainless steel.

### CROSS-REFERENCE TO RELATED APPLICATIONS

The present application is a U.S. National Stage Application under 35 U.S.C. § 371 of International Application No. PCT/US2023/034470, filed on Oct. 4, 2023, which in turn claims the benefit of priority from U.S. Provisional Application No. 63/414,052, filed on Oct. 7, 2022. The entire disclosure of the above applications is incorporated herein by reference.

### FIELD OF TECHNOLOGY

The present disclosure is in the field of pad eyes, and more particular in the field of a pad eye assembly with pan fittings.

### BACKGROUND

Pad eyes are one of the most universally used tie-down items in maritime, industrial, transportation, and other industries. They are used for a variety of purposes, from a simple tie down or lashing of a cargo to deck of a transportation vehicle or trailer, to complicated lashing operations involving multiple tie-down points. Pad eyes vary in their geometry depending on the purpose they are being used for as well as type of attachment fitting.

### SUMMARY

The present disclosure includes a pad eye system comprising one or more rings, wherein the one or more rings are structured respectively as one or more geometric shapes with a consistent material dimeter throughout. The present disclosure also includes one or more pad eyes, wherein the one or more pad eyes respectively include one or more pad eye bases attached respectively to the one or more rings and configured to rotate respectively about a common axis, wherein the one or more pad eye bases include a first bore and one or more mounting holes.

According to some embodiments of the present disclosure, one or more mounting holes of the pad eye system are round. According to some embodiments of the present disclosure, one or more mounting holes of the pad eye system are square. According to some embodiments, the shape of the ring can be round, triangle, square or other shape to fit an appropriate attachment. According to some embodiments of the present disclosure, the pad eye system is mounted in mating pan fittings that are surface, recessed, or semi-surface/recessed.

### BRIEF DESCRIPTION OF THE DRAWINGS

FIG. 1 is a perspective view of a dee ring.

FIG. 2 is a perspective view of a rectangle ring.

FIG. 3 is a perspective view of a triangle ring.

FIG. 4 is a perspective view of a 1-hole pad eye base.

FIG. 5 is a perspective view of a 2-hole (square) pad eye base.

FIG. 6 is a perspective view of a 3-hole pad eye base.

FIG. 7 is a perspective view of a 4-hole (double) pad eye base.

FIG. 8 is a perspective view of a 1-hole surface pan fitting.

FIG. 9 is a perspective view of a 2-hole surface pan fitting.

FIG. 10 is a perspective view of a 3-hole surface pan fitting.

FIG. 11 is a perspective view of a 4-hole surface pan fitting.

FIG. 12 is a perspective view of a 1-hole recessed pan fitting.

FIG. 13 is a perspective view of a 2-hole recessed pan fitting.

FIG. 14 is a tabular view of a variety of pad eye assembly system configurations.

FIG. 15 is a tabular view of a variety of 1-hole pan fitting assembly configurations.

FIG. 16 is a tabular view of a variety of 2-hole pan fitting assembly configurations.

FIG. 17 is a tabular view of a variety of 3-hole pan fitting assembly configurations.

FIG. 18 is a tabular view of a variety of 4-hole pan fitting assembly configurations.

FIG. 19 is a tabular view of a variety of 1- and 2-hole pad eye system configurations.

FIG. 20 is a tabular view of a variety of 3-hole pad eye system configurations.

FIG. 21 is a tabular view of a variety of 4-hole pad eye system configurations.

### DETAILED DESCRIPTION

The present disclosure includes a pad eye system. These pad eyes can comprise various shaped rings in various combinations with several mounting bases. Additionally, the pad eye assembly of the present disclosure can further be combined with pan fittings in either a surface or recessed type mount to create additional fittings. According to some implementations, the components and/or fittings are made from metal, such as stainless steel.

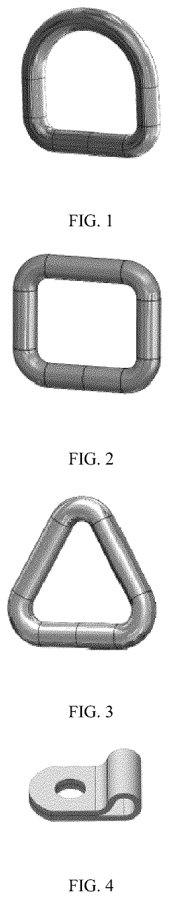

The present disclosure introduces pad eye components which comprise one or more pad eye assemblies. FIG. 1 shows a perspective view of a dee ring. FIG. 2 shows a perspective view of a rectangle ring. FIG. 3 shows a perspective view of a triangle ring. According to some implementations, the dee, rectangle and triangle rings include wire diameter sizes of ⅛″, 3/16″, ¼″, 5/16″, ⅜″ or ½″. According to some implementations, there may be a total of 18 rings.

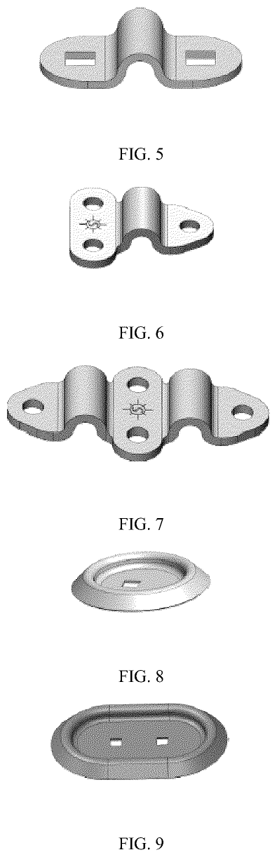

The pad assemblies of the present disclosure also include pad eye bases. These bases can be available in multiple configurations based on the number of mounting holes. FIG. 4 shows a perspective view of a 1-hole pad eye base. FIG. 5 shows a perspective view of a 2-hole (square) pad eye base. FIG. 6 shows a perspective view of a 3-hole pad eye base. FIG. 7 shows a perspective view of a 4-hole (double) pad eye base. According to some implementations, each configuration can have sizes to match respective ring diameters, and each configuration may also be available in round or square mounting holes.

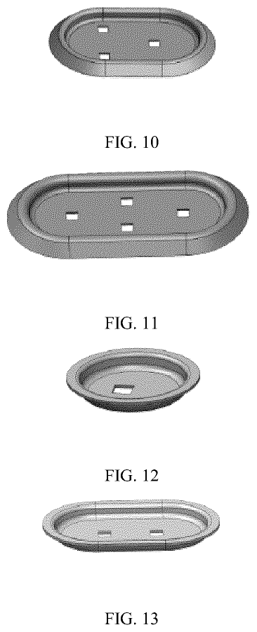

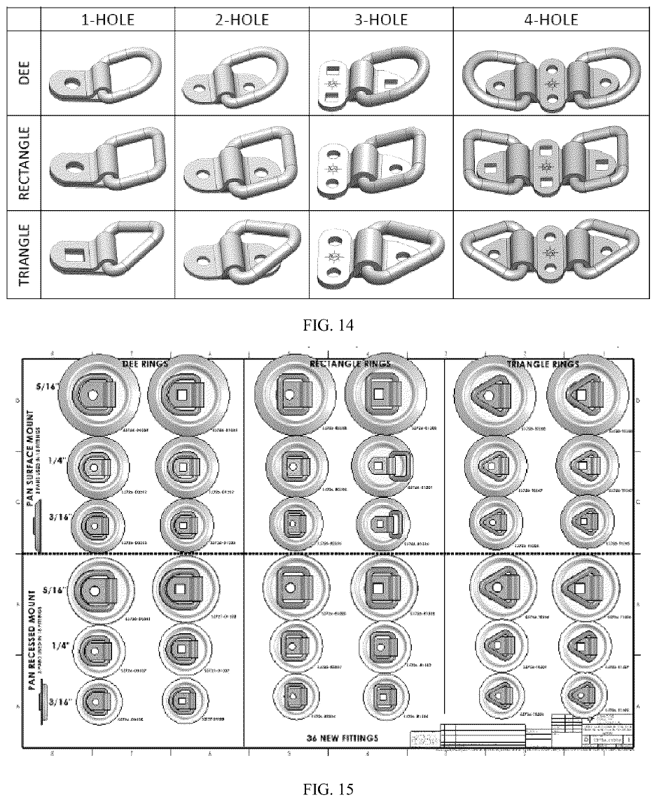

The pad assemblies of the present disclosure also include pan fittings. These fittings can be available in multiple shape configurations to fit corresponding pad eye bases with same mounting hole pattern. According to some implementations, pans may be either surface or recessed (flush) type. FIG. 8 shows a perspective view of a 1-hole surface pan fitting. FIG. 9 shows a perspective view of a 2-hole surface pan fitting. FIG. 10 shows a perspective view of a 3-hole surface pan fitting. FIG. 11 shows a perspective view of a 4-hole surface pan fitting. FIG. 12 shows a perspective view of a 1-hole recessed pan fitting. FIG. 13 shows a perspective view of a 2-hole recessed pan fitting. According to some implementations, it is also possible to have 3- and 4-hole recessed pan fitting.

FIG. 14 shows a tabular view of a variety of pad eye assembly system configurations. According to some implementations of the present disclosure, typical pad eye assemblies are configurable with any of the ring shapes and sizes to any corresponding sized base plate as illustrated in FIG. 14. Additionally, each pad eye assembly can be available with round or square mounting hole bases, as detailed in the system arrays of FIGS. 19-21.

As previously introduced, the present disclosure includes a variety of pan fitting assemblies. According to some implementations, one or more of the above pad eye configurations can include surface or recessed pan fittings.

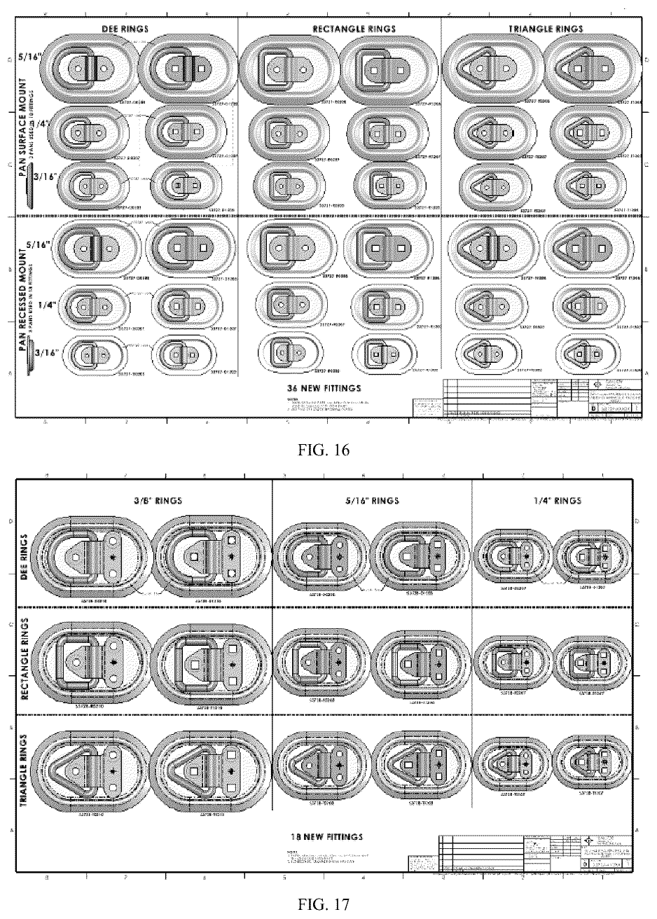

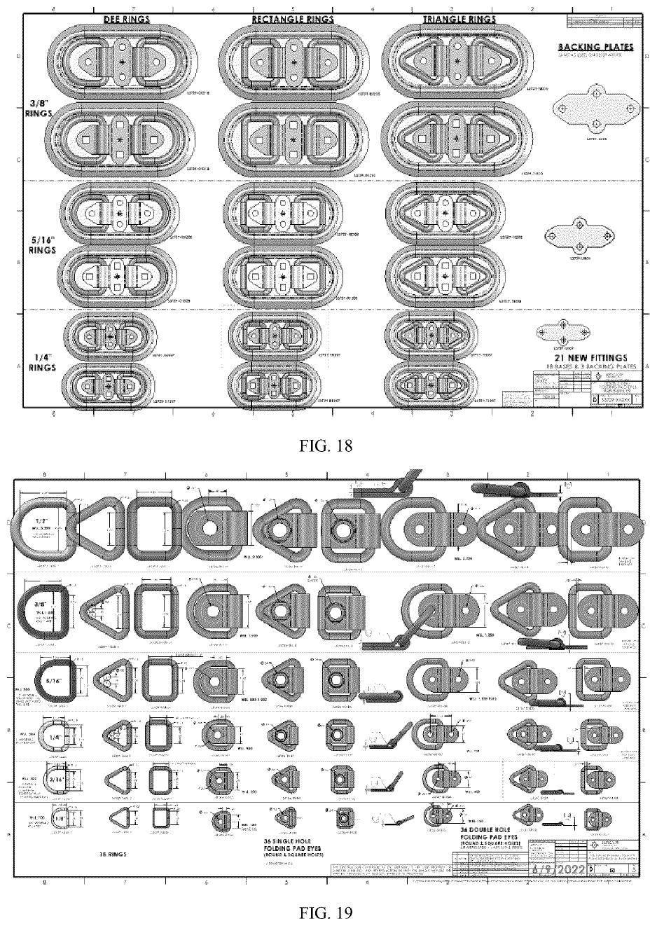

FIGS. 15-18 detail illustrative examples of a limited number of pans, with additional sizes possible. FIG. 15 shows a tabular view of a variety of 1-hole pan fitting assembly configurations, including round 1-hole surface and recessed pans (size 3/16″, ¼″ & 5/16″ shown). FIG. 16 shows a tabular view of a variety of 2-hole pan fitting assembly configurations, including oblong 2-hole surface and recessed pans (size 3/16″, ¼″ & 5/16″ shown). FIG. 17 shows a tabular view of a variety of 3-hole pan fitting assembly configurations, including oblong 3-hole surface pans in 3 sizes (recessed pans available, not shown). FIG. 18 shows a tabular view of a variety of 4-hole pan fitting assembly configurations, including oblong 4 hole surface pans in 3 sizes (recessed pans also available, not shown).

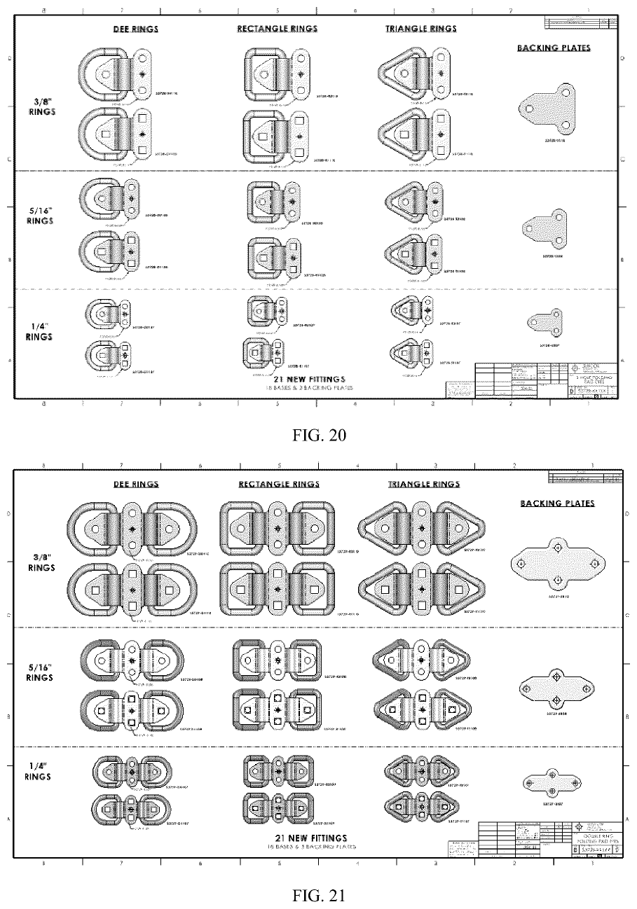

As previously introduced, each pad eye assembly can be available with round or square mounting hole bases, as detailed in the system arrays of FIGS. 19-21. FIG. 19 shows a tabular view of a variety of 1- and 2-hole pad eye array system configurations. FIG. 20 shows a tabular view of a variety of 3-hole pad eye array system configurations, which can include additional smaller and larger sizes. FIG. 21 shows a tabular view of a variety of 4-hole pad eye system configurations, which can include additional smaller and larger sizes.

According to other implementations, the present disclosure includes a pad eye system including a first ring with a relatively D shaped of first diameter material and inner height and width of a first value, a second ring with a relatively rectangle shape and inner height and width of a second value, and diameter material diameter of a first value, a third ring with a relatively triangle shape and inner height and width of a third value, and diameter material diameter of a first value. The present implementation also may include a first pad eye comprising a base attached to any of the first through third rings, configured to rotate about a common axis, the first pad eye comprising a first pad eye base, with a first bore nearly equal to ring of first diameter and a first pad eye base with one mounting hole. The present implementation also may include a second pad eye comprising a base attached to any of the first through third rings, configured to rotate about a common axis, the second pad eye comprising a second pad eye base, with a first bore nearly equal to ring of first diameter and a second pad eye base with two mounting holes. The present implementation may further include a third pad eye comprising a base attached to any of the first through third rings, configured to rotate about a common axis, the third pad eye comprising a third pad eye base, with a first bore nearly equal to ring of first diameter and a third pad eye base with three mounting holes. The present implementation may additionally include a fourth pad eye comprising a base attached to any of the first through third rings, configured to rotate about a common axis, the fourth pad eye comprising a fourth pad eye base, with a first bore nearly equal to ring of first diameter and a fourth pad eye base with four or more mounting holes.

According to some implementations, the present disclosure includes a pad eye system comprising an nth pad eye with a ring diameter of nth value, an nth geometric shape, and a base with an nth value of mounting holes, wherein n is a positive integer greater than 3. According to some implementations, the present disclosure includes a pad eye system where the mounting holes are round or square. According to some implementations, the present disclosure includes a pad eye system mounted in mating pan fittings that can be surface, recessed or semi surface/recessed.

1. A pad eye system comprising,
a first ring, with a first relatively D-shaped ring and material diameter, and a first width, first diameter, and first inner height of a first value;
a second ring, with a first relatively rectangular-shaped ring and material diameter, and a second width, second diameter, and second inner height of a first value;
a third ring, with a first relatively triangular-shaped ring and material diameter, and a third width, third diameter, and third inner height of a first value;
a first pad eye comprising a base attached to any of the first through third rings, configured to rotate about a common axis, the first pad eye comprising:
a first pad eye base, with a first bore nearly equal to the first diameter of the first ring; and
one mounting hole;
a second pad eye comprising a base attached to any of the first through third rings, configured to rotate about a common axis, the second pad eye comprising:
a second pad eye base, with a first bore nearly equal to the first diameter of the first ring; and
two mounting holes;
a third pad eye comprising a base attached to any of the first through third rings, configured to rotate about a common axis, the third pad eye comprising:
a third pad eye base, with a first bore nearly equal to the first diameter of the first ring; and
three mounting holes;
a fourth pad eye comprising a base attached to any of the first through third rings, configured to rotate about a common axis, the fourth pad eye comprising:
a third pad eye base, with a first bore nearly equal to the first diameter of the first ring; and
at least four mounting holes.

2. The pad eye system of claim 1, further comprising:
an n^{th} pad eye with a ring diameter of n^{th} value;
an n^{th} geometric shape and a base with an n^{th} value of mounting holes; and
where n is a positive integer greater than 3.

3. The pad eye system of claim 1, wherein the one or more mounting holes are round.

4. The pad eye system of claim 1, wherein the one or more mounting holes are square.

5. The pad eye system of claim 1, wherein the pad eye system is mounted in mating pan fittings that are surface, recessed, or semi-surface/recessed.

6. The pad eye system of claim 1, wherein the pad assembly contains more than one ring of the same shape or combination of different shapes.

7. The pad eye system of claim 1, wherein the pad eye assembly contains a backing plate of any material.

8. The pad eye system of claim 1, wherein the material of the ring, base or pan fitting is non-metallic material.

9. The pad eye system of claim 8, wherein the non-metallic material is a plastic material, such as nylon.
